(19) United States
(12) Patent Application Publication
(10) Pub. No.: US 2007/0000790 A1
(43) Pub. Date: Jan. 4, 2007

(54) Method and device for electrochemical disinfection of water

(76) Inventors: Jose Morales, Claira (FR); Claude Bernard, Cazilhac (FR); Didier Ginestet, Saint Laurent De La Salanque (FR); Stephane Morales, Claira (FR); Jean-Marie Morales, Claira (FR)

Correspondence Address: JEROME D. JACKSON (JACKSON PATENT LAW OFFICE), 211 N. UNION STREET, SUITE 100, ALEXANDRIA, VA, 22314, US

(21) Appl. No.: 10/546,263

(22) PCT Filed: Feb. 9, 2004
(86) PCT No.: PCT/FR04/00296

§ 371 Date: Aug. 22, 2005

(30) Foreign Application Priority Data
Feb. 24, 2003 (FR) 03/02315

(51) Int. Cl. C02F 1/461

(52) U.S. Cl. 205/742

(57) ABSTRACT

The invention relates to a method for electrochemical disinfection of water without addition of chemical products, by means of at least one cell, comprising an anode (1) and a cathode (2), contained in a housing (3), provided with inlet (4) and outlet means (5) for water. Said method is characterised in essentially comprising: a) circulating the water for disinfection in a laminar or quasi-laminar manner, in the space between the catalytic faces opposite the anode (1) and the cathode (2) of a given cell, b) using opposing catalytic faces with identical surfaces, c) supplying electrically each pair of anode and cathode by means of connections (1A) and (2A), arranged in opposition.

The invention concerns a method for electrochemical disinfection of water without addition of chemical products, by means of at least one cell, comprising an anode and a cathode contained in a housing provided with inlet means and outlet means for water and supplied by an electrical current.

The method in question exploits, in combination:
a) the direct effect tied to the actions of oxidation at the anode and of reduction at the cathode on the dissolved organic matter: virucidal, bactericidal and bacteria-static effects;
b) the indirect effect tied to the action of the oxidants generated by the electrolysis of the water: complementary bactericide effect and residual bacteria-static effect.

The possible applications of this type of method consist in:
contributing to eradicating Legionella from hydraulic installations;
decontaminating water intended for human consumption in the interior networks (including hot water);
to act as a disinfectant agent notably in the medical domain.

Legionella is a bacterium living in soft water. This bacterium is principally found in stagnant warm washroom water, in tartar deposits or in the water of air condenser towers. It proliferates in water circuits in which the temperature oscillates between 25° and 45° C. Legionnaire bacterium develops and is fixed above all in the presence of elevated concentrations of calcium, of magnesium and of residual metals such as iron, copper, zinc and from sludges most often caused by corrosion and from scaling.

Legionnaires' disease is a serious infection of the respiratory tracts caused by Legionella. The transmission is aerial and affects mostly persons particularly vulnerable, most often in the context of public establishments, hospitals, clinics, care centers, retirement homes, thermal baths, and thalassotherapies . . . .

The prevention of this intense infectious syndrome is based on the one hand on the surveillance of the human cases and the other hand on the surveillance of the contamination of hydric devices. A long-term prevention cannot be envisioned except in the context of permanent treatment. At this time, the measures authorized in France are based on super chlorination or overheating.

Relating to super chlorination, chlorine has a corrosive action on pipe work, and it is instable at a temperature of greater than 20° C. The risk of formation of haloforms from chlorine permanently present in the network is not excluded.

As for super heating of the network, if it carries no chemical product, the risks of burns are not negligible as the water is 60° C. at the outlet of the storage reservoirs. Furthermore, the risk of acquisition by Legionella of a resistance to elevated temperatures is not utopian.

Also, numerous trials of alternative treatments are currently being realized: chlorination-bromation, ozone, ultra-violet rays, production of ions of copper-silver etc . . . .

The electrochemical method of water treatment of the type of the invention, intended to contribute to eradicating pathogenic agents from hydraulic installations, requires no initial addition of reactive chemicals because it generates in situ from the hydrogen peroxide, bactericidal oxidant. Owing to this technique, the hydrogen peroxide generated from the dissolved oxygen (cathodic reduction) has an appreciable residual effect and induces oxidation products at inoffensive levels (continuously controlled by current measurement), as opposed to the most utilized oxidants such as chlorine.

The water passes through an electroperoxidation module using catalytic electrodes and undergoes an electrochemical treatment. This treatment induces on the one hand a direct effect, due to the electric field, and on the other hand an indirect effect due to the chemical reactions produced at the electrodes and in the electrolytic bath.

The direct effect, by passing between the electrodes, produces a bactericidal or bacteria-static effect (Pseudomonas, Coliformes, Legionelles . . . ).] One observes a bactericidal effect when a contaminated solution is subject to an electric field greater than the field existing at the level of the bacterial membrane.

The indirect effect, obtained by oxidation of the halides (Cl⁻, Br⁻, I⁻) and/or of the water and/or by reduction of the dissolved oxygen, permits generation of the oxidants (HClO, ClO⁻, Cl₂, ClO₂⁻, ClO₃⁻HBrO, BrO⁻, BrO₃⁻, HOI, I₃⁻, OH* . . . and notably H₂O₂). This indirect effect, by prolonged contact with these oxidants generated by electrochemical synthesis route, permits a supplemental abatement of the bacteria and a protection of the water during transportation and storage up to the usage points; the action is prolonged at the outlet of the electrolyzer (providing residual disinfection).

The reactivity of the hydrogen peroxide is due to essentially to its strong generating power of radical reactions in the presence notably of metallic catalysts. The hydrogen peroxide can act due to this fact on the microorganisms by production of free radicals that attack the cellular membrane, the lipids, the intervening enzymes In the respiratory cycle or the synthesis of proteins, and other essential components such as DNA and RNA. Similarly for the hypochlorous acid, the chlorine oxygenates the cellular membrane, deactivates the enzymes and denatures the nucleic acids of the pathogenic agents.

The corresponding state of the art is described in patent FR2784979 which discusses a method of electrochemical disinfection of water or effluents exploiting the direct and indirect effects mentioned above and of a device for its implementation composed of at least an electrolyzer provided with a porous anode and cathode through which pass the water to be disinfected.

The system in question presents the following characteristics, limitations or disadvantages:
the electrodes are differentiated and the fluid circulates by percolation through them;
the anode is made of titanium and is covered with a catalyst and the porous cathode is made of carbon;
the electrodes are separated or not by a membrane;
the inversion of the polarities is problematic, the carbon electrode being susceptible to oxidize when it is anodically polarized;
the porous carbon electrode carbonates in mass and as a result is difficult to electrochemically decarbonate: chemical decarbonatations are frequent.
the electrical contact on the porous carbon electrode is quite problematic;
in the case of overflow or of surges, the electrodes in the cell can be very seriously damaged;
there exists the possibility of clogging with time or rapidly with a loaded fluid: in the latter case the electrodes can be destroyed;
an isolated porous separator appears to be necessary between the electrodes for avoiding the short circuits by the carbon fibers.
there is the possibility of driving carbon micro particles in the treated water;
in the case of prolonged anodic polarization of the carbon electrode, there is the possibility of destruction of the electrode with production of sometimes colored by-products and which can be toxic: this case is also possible even with massive non percolante carbon electrodes;
only the production of hydrogen peroxide is sought.

The corresponding state of the art is also described in the patent WO9521795 which discusses an electro catalytic device for the treatment of water, intended to increase the concentration of dissolved oxygen and which is characterized in that it implements:
concentric circular electrodes, in other words of different surface areas, which is not in itself a problem in relation to the pursued goal;
means intended to reduce even to eliminate the turbulences that are at the origin of the concentration of dissolved oxygen and to not create a laminar flow between the electrodes.

The examined application is characterized in that it combines, to achieve the pursued goals, the following three characteristics:
a) the maintenance of a laminar circulation flow between two opposing electrodes for the purpose of promoting electrochemical reactions on each electrode and avoiding the destruction of the products formed on an electrode by the reaction on the other electrode and the shock tied to the variation of pH at the outlet by the mix of the two solutions;
b) the utilizations of identical opposing surface electrodes for the purpose of permitting the inversion of the polarities in best conditions, the current density being identical on the two electrodes, with the effect of avoiding a premature degradation of one with respect to the other from the fact of decarbonation that may not be identical and secondary reactions which could be greater on the electrode of the smaller dimensions (higher current density);
c) the supplying of the anodes and of the cathodes in opposition for the purpose of compensating for the variations of the current density from one end to the other of each electrode.

The corresponding state of the art is also described in the patent DE19951461, which discusses an elect catalytic device for the treatment of water, which includes circular, concentric electrodes.

This document brings no new technical element to be taken into consideration.

The invention concerns a method that is characterized essentially in that it consists:
a) causing the water to be disinfected to circulate, in a laminar or quasi-laminar manner, in the space between the catalytic faces opposing the anode and the cathode of a given cell;
b) using opposing catalytic faces that possess identical surface areas;
c) electrically supplying each pair of anode and cathode by connections assembled in opposition.

Several cells can be assembled hydraulically, in series in order to cumulate their disinfectant effects.

Several cells can be assembled, hydraulically, in parallel in order to cumulate their flow rates.

The aforementioned cells can be contained in a common housing provided with inlet means and outlet means equally common to the assembly of the aforementioned cells.

The cells can be supplied, by electric current:
either by a first connection connecting the assembly of the cathodes;
or by two connections supplying only the end electrodes, an anode for one and a cathode for the other, the other electrodes functioning in bipolarization.

The invention also concerns a device, for the implementation of the aforementioned method, which is characterized essentially in that each cell includes two electrodes, shaped as plates, composed of, or covered with, an electro conductive material.

The aforementioned material is covered by a catalyst of electro-chemical oxidation reactions of the water and of the dissolved oxygen.

The system in question presents the following characteristics and advantages:
each cell is symmetric: the two electrodes are identical and are covered by catalyst;
the contacts on the electrodes are welded without difficulty;
the fluid circulates between the electrodes, which has the effect of generating very little discharge (and therefore loss of pressure) as opposed to the technique of percolation;
the totality of the water flow is subject to the electric field since it travels between the anode and the cathode on their entire surface: the effect of direct disinfection fully plays its role in this solution;
the inversion of polarity does not pose difficulties for the decarbonation of the cathode;
the fluid circulates in a laminar or quasi-laminar flow;
the number of electrodes placed in a common housing is not limited: the only limitation being the electrical power of the supply (proportional to the number of electrodes);
overflows and surges do not have influence except on the oxidant yield of the electrolysis;
the automation of the electrolysis is easier: the continued control of efficiency is made possible and the variations of the intensity of the current and of the voltage are easily interpretable and modifiable;
multiple oxidants are produced, and are not limited only to hydrogen peroxide, with the effect of limiting the habituation phenomenon of the microbiologic flora and notably the selection of mutant germs resistant to the hydrogen peroxide;
clogging of the cell is difficult, even with water loaded with diverse particles, as opposed to the devices utilizing carbon felt where the decarbonation was almost impossible to realize concretely because scaling was deeply effected; only an acid washing permitted partial decarbonation but with deterioration of the felt and losses of carbon fibers incompatible with utilization on water intended for human consumption;
the cell can always be clogged if the decarbonation is not effected, but in this case the voltage of the electrolysis will exceed the normal values before complete clogging (in the case of multiple electrodes) and the alarm will be triggered: one will be able to conduct a cleaning of the cell in this case with the aid of food acid products;
there is no generation of undesirable by-products;
the presence of a pre-electrolysis upstream is no longer necessary in this case.

The characteristics and the advantages of the invention will appear more clearly with the reading of the detailed description that follows of at least one preferred mode of implementation given by way of non limiting example and represented in the annexed drawings.

In the drawings:

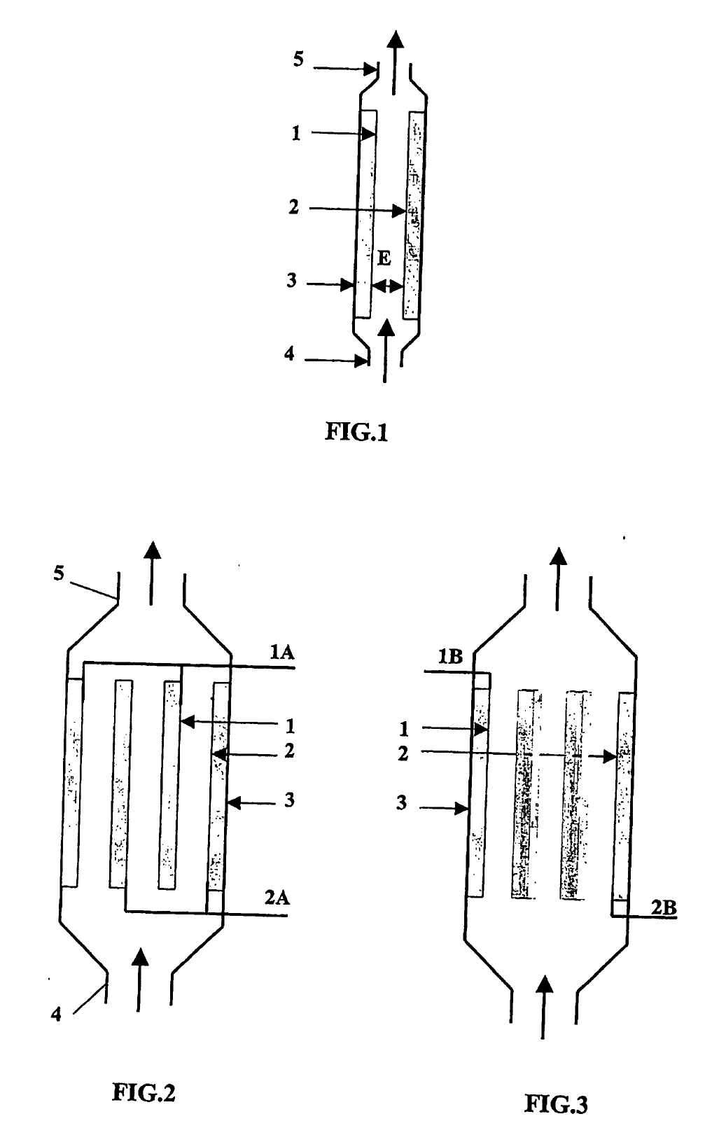

FIG. 1 is an interior, open circuit, schematic view of a disinfection cell according to the invention;

FIG. 2 is an interior, open circuit, schematic view of several disinfection cells according to the invention assembled in parallel hydraulically and electrically;

FIG. 3 is an interior, open circuit, schematic view of several disinfection cells according to the invention assembled in parallel hydraulically and in bipolarization electrically;

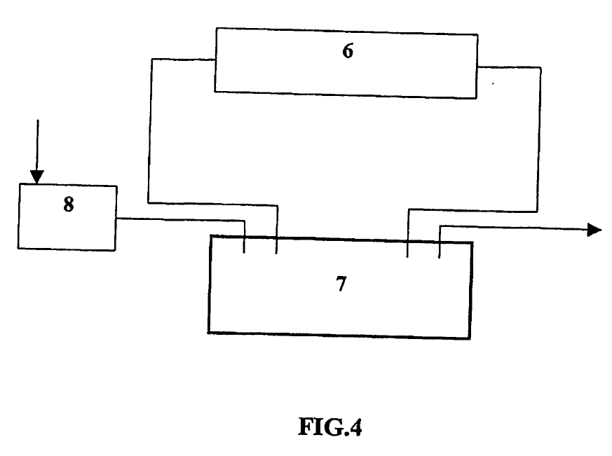

FIG. 4 is an interior, closed circuit, schematic view of a disinfection module according to the invention associated with a reservoir and unit for electrochemical pretreatment or filtration.

The invention concerns a method for electrochemical disinfection of water, without addition of chemical product, by means of at least a cell comprising (FIG. 1) an anode (1) and a cathode (2) contained in a housing (3) provided with inlet means (4) and outlet means (5) for the water and supplied by an electric current.

The aforementioned method exploits, in combination:
a) the direct effect tied to the actions of oxidation at the anode and of reduction at the cathode on the dissolved organic matter: virucidal, bactericidal and bacteria-static effects;
b) the indirect effect tied to the action of the oxidants generated by the electrolysis of the water: complementary bactericidal effect and residual bacteria-static effect.

It consists essentially:
a) in causing the water to be disinfected to circulate, in a laminar or quasi-laminar manner, in the space between the catalytic faces opposing the anode and the cathode of a given cell;
b) in using opposing catalytic faces that possess identical surface areas;
c) in electrically supplying each pair of anode and of cathode by connections assembled in opposition.

The laminar or quasi-laminar flow, in the space between the opposing catalytic faces of the electrodes of a given cell: a) is obtained by means of the shape of the catalytic faces of the opposing electrodes that define a space of identical dimension in all respects and that possess identical surface areas; b) is maintained by means of the shape and of the dimensions of the water inlet means and outlet means.

According to two variations of use of the invention, several cells can be hydraulically assembled:
a) in series in order to cumulate their disinfectant effects;
b) in parallel in order to cumulate their flow rates.

The cells can be, in these two cases, contained in a common housing provided with inlet means and outlet means equally common to the assembly of the aforementioned cells.

The flow rate of the fluid to be treated must be such that the total production of oxidants (concentration x flow rate) is constant.

According to two variations of use of the invention, in the case of cells assembled hydraulically in parallel,:
a) the cells (FIG. 2) can be supplied, by electric current, by a first connection (IA) connecting the assembly of the anodes and by a second connection (2A) connecting the assembly of the cathodes, the aforementioned connections being assembled in opposition;
b) only the end electrodes (FIG. 3) are supplied, by electrical current, by a first connection (1 B) for the anode and by a second connection (2B) for the cathode, the other electrodes functioning in bipolarization.

The cells can be assembled hydraulically in series or in parallel but not necessarily electrically: each cell being in this case supplied separately.

According to different variations of use of the invention, an electrochemical treatment module (6):
a) can be immersed in a treatment or decantation reservoir;
b) can be placed (FIG. 4) in a loop of a treatment or decantation reservoir (7);
c) can be coupled (FIG. 4) to a filtration system (8), notably of the granular types or with membranes, and/or with another electrochemical treatment module.

The cell(s) can be supplied by continuous and/or pulsed current.

The inversion of polarity of the electrodes is programmed according to a percentage fully determined from the elevation of the voltage function of the characteristics of the water to be treated and/or according to a temporization fully determined depending on the quality of the water.

The device for the implementation of the aforementioned method uses cells that each include two electrodes (1) and (2), shaped as plates, composed of, or covered with, an electro conductive material.

The electro conductive material is covered by a catalyst of the electrochemical oxidation reactions of the water and of the dissolved oxygen.

The electro conductive material can be advantageously of titanium and the catalyst can be advantageously a mixed oxide of iridium and of ruthenium.

The space between the electrodes (1) and (2) is generally ranging between 2 and 6 mm depending on the conductivities of the water utilized.

The electrodes have thicknesses generally ranging between 1 and several mm. The supports of the lateral sides of the electrodes are provided with slits adopted to receive the aforementioned sides to avoid the boundary effect. The free faces are covered with catalyst to avoid corrosion and favorize decarbonatation.

The electrochemical treatment modules can include 2, 4, 6 or more electrodes.

The electrodes are separated by a distance such that the precipitation of calcium carbonate does not block the passage of the fluid.

The arrangement of the different constituent subassemblies the cell is such that they cannot create too much turbulence.

The continuous and/or pulsed current utilized has a value generally ranging between 1 and 10 A per dm².

The optimal pressure of the water in the cell is 3 bars.

When the cells are assembled in a loop on a tank, they produce a volume of water with a larger total concentration of oxidants, for example to protect the treated water from any recontamination by the germs and/or organic matter in the reservoirs and distribution networks, up to the usage points. This water can be subsequently injected into the water to be treated. In this application only the indirect effect is utilized.

This implementation can be utilized for disinfecting apparatus, surgical for example, by immersion in the tank described above.

The system can also be utilized as tertiary wastewater treatment or principal or secondary treatment of recreational or therapeutic water (thermal, thalassotherapie, . . . water).

For the applications cited above as well as for the decontamination of water of refrigeration towers or any other air treatment systems, the implementation can be different in orientation or the sets of electrodes will be bare (not enclosed in a cell).

The liquid mass can then be placed in contact with the oxidants generated by convectous movements (phenomena of convection). This type of implementation can be adopted, for example in water buffers and water reservoirs.

Several sets of electrodes can be implemented in a common tank.

The bare sets of electrodes will also be able to be implemented integrated with the interior or the exterior of piping and enveloping in the water to be treated (for example for the basins in water recycling networks).

Water treated by electroperoxidation whatever the type of implementation can possibly be utilized for medical applications (therapies).

When this technique is coupled to a granular filtration system, a synergy of technologies is operated since the micro filtration totally stops the parasites and bacteria but not the viruses whereas the electroperoxidation participates to the destruction of the viruses.

Furthermore the electroperoxidation brings a residual disinfections power to the water that cannot be provided by micro filtration.

Finally, the electroperoxidation participates in the degradation of dissolved organic matter whereas micro filtration only stops the matter in suspension (particles greater than 0.1 microns or 0.01 microns for the ultra filtration).

Of course, the invention is not limited to the implementation modes described and represented for which one will be able to foresee other variations, in particular in: —the nature, the shape and the dimensions of the electrodes belonging to a given treatment cell; —the nature of the catalysts used; —the number of pairs of electrodes belonging to a given treatment module; —the nature and the shape of the housings as well as their inlet means and outlet means for the water to be treated; and the extension to other disinfection applications of different waters in combination or not with other means of disinfection and/or of filtrations and, in open circuit or in closed circuit.

1. Electrochemical disinfection method of water, without addition of chemical product, by means of at least a cell comprising an anode (1) and a cathode (2) contained in a housing (3) provided with inlet means (4) and outlet means (5) for the water and supplied by an electric current; the aforementioned method exploits, in combination, on the one hand, the direct virucidal, bactericidal and bacteria-static effect tied to the actions of oxidation at the anode and of reduction at the cathode on the dissolved organic matter, on the other hand, the indirect complementary bactericidal and residual bacteria-static effect tied to the action of the oxidants generated by the electrolysis of the water;
characterized in that it consists:
a) in causing the water to be disinfected to circulate, in a laminar, or quasi-laminar manner, In the space between the catalytic faces opposing the anode and the cathode of a given cell;
b) in using opposing catalytic faces that possess identical surface areas;
c) in electrically supplying each pair of anode and of cathode by connections assembled in opposition.

2. Method, according to claim 1, characterized in that several cells are assembled, hydraulically, in series in order to cumulate their disinfectant effects.

3. Method, according to claim 1, characterized in that several are assembled, hydraulically, in parallel in order to cumulate their flow rates.

4. (canceled)

5. Method, according to claim 3, characterized in that the cells are electrically supplied by a first connection (1A) connecting the assembly of the anodes and by a second connection (2A) connecting the assembly of the cathodes and in that the aforementioned connections are assembled in opposition.

6. Method, according to claim 3, characterized in that only the end electrodes are supplied, by electrical current, by a first connection (1B) for the anode and by a second connection (2B) for the cathode, the other electrodes functioning in bipolarization.

7-16. (canceled)
